(19) United States
(12) Patent Application Publication
(10) Pub. No.: US 2023/0372774 A1
(43) Pub. Date: Nov. 23, 2023

(54) STROLLER ARM EXERCISER

(71) Applicant: Vanessa Pomante, Toronto (CA)

(72) Inventor: Vanessa Pomante, Toronto (CA)

(21) Appl. No.: 18/248,061

(22) PCT Filed: Oct. 6, 2021
(86) PCT No.: PCT/CA2021/051400

§ 371 Date: Apr. 6, 2023

Related U.S. Application Data
(60) Provisional application No. 63/088,909, filed on Oct. 7, 2020.

(51) Int. Cl. A63B 23/12; A63B 21/00; A63B 23/035; A63B 21/16; A63B 21/04; B62B 9/20

(52) U.S. Cl. CPC A63B 23/12; A63B 21/4035; A63B 23/03541; A63B 21/16; A63B 21/00069; A63B 21/0421; A63B 21/4047; B62B 9/206; A63B 69/0028

(57) ABSTRACT

An exercise apparatus is used for exercising an upper body of a user, specifically arms of the user. The exercise apparatus is attachable to (and detachable from) a stroller. The exercise apparatus includes a main frame, a left handle assembly, a left resistance assembly, a right handle assembly, and a right resistance assembly. The left handle assembly and the right handle assembly are rotatable about a horizontal axis. The left resistance assembly provides resistance to the left handle assembly and the right handle assembly provides resistance to the right handle assembly to further exercise the arms of the user.

### CROSS-REFERENCE TO RELATED APPLICATION

The present application is related to and claims priority to U.S. Provisional Patent Application No. 63/088,909 filed Oct. 7, 2020, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of strollers existing art and more specifically relates to an exercise apparatus for attachment to a stroller.

### RELATED ART

Lack of physical fitness is an increasing area of concern in modern society. However, due to the fast nature of everyday life, it is often difficult to find time to exercise. Further, gym memberships are generally expensive. This is especially troublesome for parents with newborn babies as new parents are often exhausted, are unable to afford gym memberships and/or may not be able to find the time to exercise in conventional ways.

Baby strollers are commonly used as a safe and convenient way for transporting a child. Oftentimes, baby strollers are utilized by an adult to take the child on a long walk, thereby allowing both the parent and child to enjoy the fresh air and surroundings. As such, walking a baby in a stroller is a convenient way to get exercise whilst spending time and taking care of the child. However, although the parent is exercising their legs and getting cardio exercise, the parent has to hold onto the stroller to ensure security of the child in the stroller. As such, they are unable to exercise their arms. Thus, a suitable solution is desired.

### SUMMARY OF THE INVENTION

In view of the foregoing disadvantages inherent in the known stroller art, the present disclosure provides a novel stroller arm exerciser. The general purpose of the present disclosure, which will be described subsequently in greater detail, is to provide a means of exercising an upper body of a user whilst pushing a stroller, allowing parents to maximize exercise whilst simultaneously caring for and spending time with their child.

An exercise apparatus is disclosed herein. As above, the exercise apparatus may be used for exercising an upper body of a user. The exercise apparatus may be configured for attachment to a stroller. The stroller may include a stroller handle. The exercise apparatus may include a main frame, a left handle assembly, a left resistance assembly, a right handle assembly and a right resistance assembly. The main frame may include a crossbar and a bracket. The bracket may be attached to a bottom of the crossbar and may be configured to attach the exercise apparatus to the stroller handle. The crossbar may include a left side and a right side relative to the stroller handle.

The left handle assembly may be located about the left side of the crossbar. The left handle assembly may include a first left horizontal section, a second left horizontal section, a left vertical section and a left substantially angled section. The left substantially angled section may be attached to the left vertical section and together may define a left grippable portion of the left handle assembly. The left vertical section may be attached to the second left horizontal section and the second left horizontal section may be pivotably attached to the first left horizontal section such that the left handle assembly may be pivotable about a horizontal axis (the horizontal axis relative to the stroller handle).

The left resistance assembly may be in communication with the left handle assembly. The left resistance assembly may include a left tension means and a left tension dial. The left tension means may be in communication with the first left horizontal section of the left handle assembly and the left tension dial may be in communication with the left tension means and configured to place the left tension means in at least a first left position and a second left position. The first left position may provide a first resistance to pivoting of the left handle assembly and the second left position may provide a second resistance to pivoting of the left handle assembly.

The right handle assembly may be located about the right side of the crossbar. The right handle assembly may include a first right horizontal section, a second right horizontal section, a right vertical section and a right substantially angled section. The right substantially angled section may be attached to the right vertical section and together may define a right grippable portion of the right handle assembly. The right vertical section may be attached to the second right horizontal section and second right horizontal section may be pivotably attached to the first right horizontal section such that the right handle assembly may be pivotable about the horizontal axis.

The right resistance assembly may be communication with the right handle assembly. The right resistance assembly may include a right tension means and a right tension dial. The right tension means may be in communication with the first right horizontal section of the right handle assembly, the right tension dial may be in communication with the right tension means and may be configured to place the right tension means in at least a first right position and a second right position. The first right position may provide a first resistance to pivoting of the right handle assembly and the second right position may provide a second resistance to pivoting of the right handle assembly.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a stroller arm exerciser, constructed and operative according to the teachings of the present disclosure.

FIG. 1 is a front perspective view of the exercise apparatus being used for exercising an upper body of a user whilst pushing a stroller, according to an embodiment of the present disclosure.

FIG. 2 is a side perspective view of the exercise apparatus illustrating an attachment plate having a plate body, a left side plate and a right side plate, according to an embodiment of the present disclosure.

FIG. 3 is a front cutaway view of the exercise apparatus illustrating the attachment plate having a side plate mover system housed therewithin for selectively extending the left side plate and the right side plate from the plate body, according to an embodiment of the present disclosure.

FIG. 4 is a top view of the exercise apparatus illustrating the attachment plate including an adjustable knob attached to each of the left side plate and the right side plate, according to an embodiment of the present disclosure.

FIG. 5 is a front perspective view of the exercise apparatus illustrating a main frame, a left handle assembly and a right handle assembly, according to an embodiment of the present disclosure.

FIG. 6 is a front view of the exercise apparatus illustrating the main frame, the left handle assembly and the right handle assembly, according to an embodiment of the present disclosure.

FIG. 7 is a bottom perspective view of the exercise apparatus illustrating the main frame, the left handle assembly and the right handle assembly, according to an embodiment of the present disclosure.

FIG. 8 is a top view of the exercise apparatus illustrating the main frame, the left handle assembly and the right handle assembly, according to an embodiment of the present disclosure.

FIG. 9A is a left side view of the exercise apparatus illustrating the main frame and the left handle assembly, according to an embodiment of the present disclosure.

FIG. 9B is a right side view of the exercise apparatus illustrating the main frame and the right handle assembly, according to an embodiment of the present disclosure.

FIG. 10 is a cross-sectional view of the exercise apparatus taken along line 7-7 of FIG. 9B and illustrating a left resistance assembly and a right resistance assembly, according to an embodiment of the present disclosure.

FIG. 11 is an exploded view of the exercise apparatus illustrating the main frame, the left handle assembly, the right handle assembly, the left resistance assembly and the right resistance assembly, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an exerciser for a stroller and more particularly to a stroller arm exerciser as used to provide a user with a means for exercising their arms whilst pushing a stroller, allowing the user to move their upper body whilst walking and/or running. This may allow the user to exercise their body whilst avoiding holding the stroller with one hand, which may be dangerous.

Generally, the stroller arm exerciser may include a device that attaches to (and is detachable from) a stroller and includes rotatable handles for allowing exercise of the arms. The rotatable handles may include a foam/gel hand grip for comfort. Further, a resistance assembly may be provided and may include at least one pressurized resistance dial for providing resistance to rotation of the rotatable handles. Further, in some embodiments, the device may include a hand brake in communication with wheels of the stroller to selectively stop motion thereof.

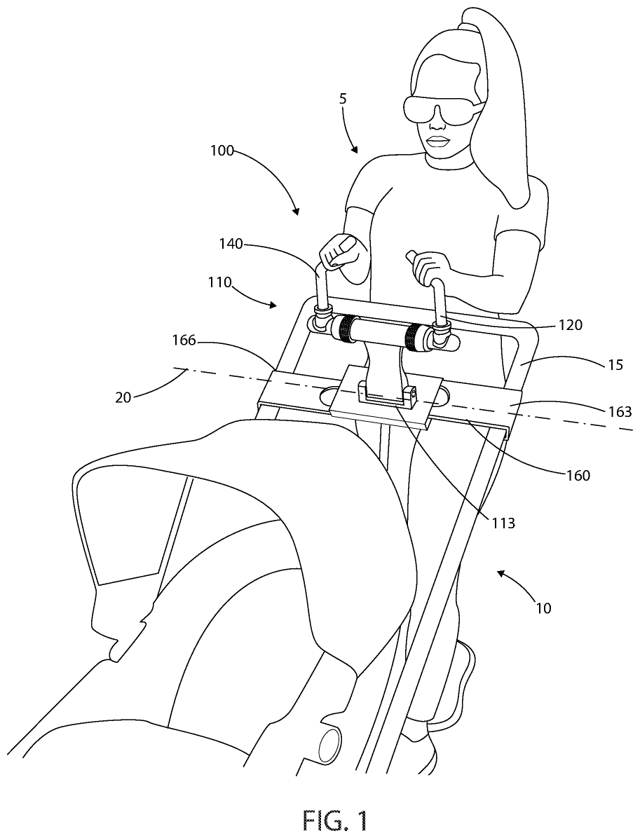

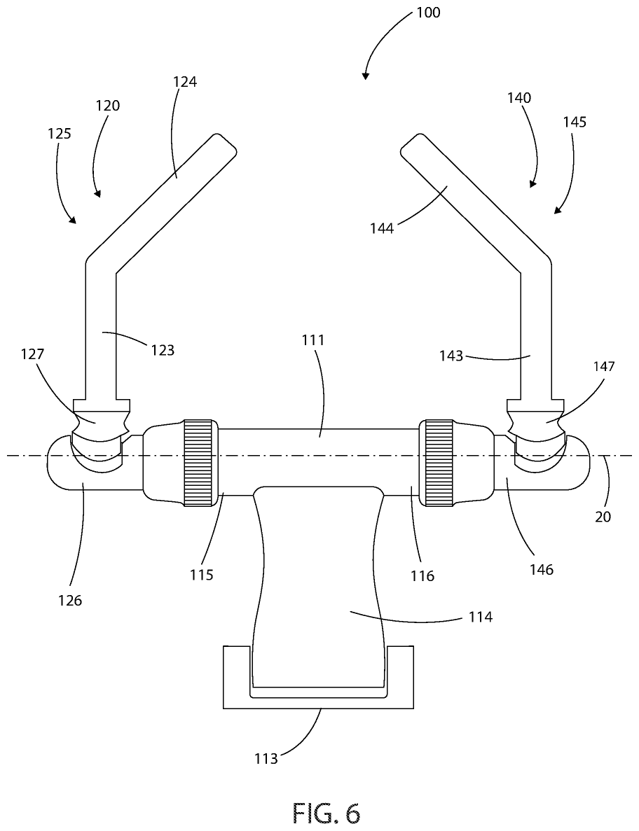

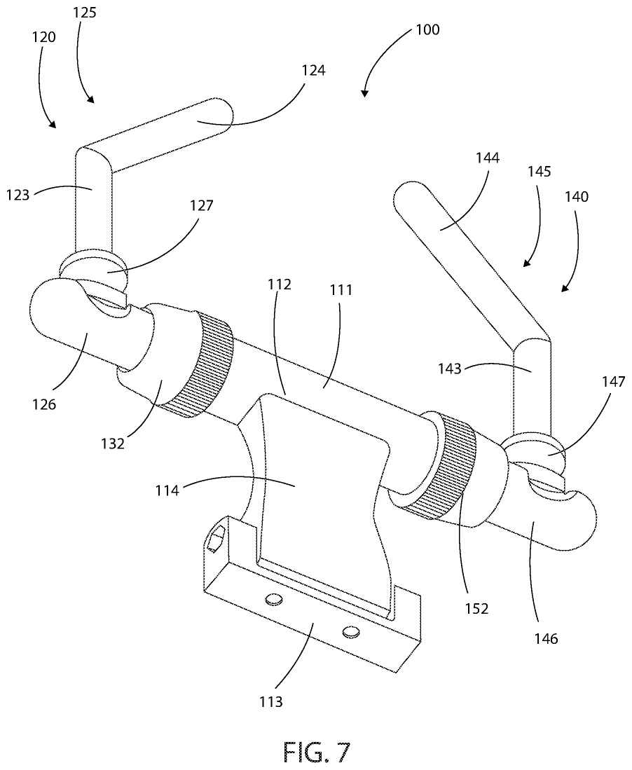

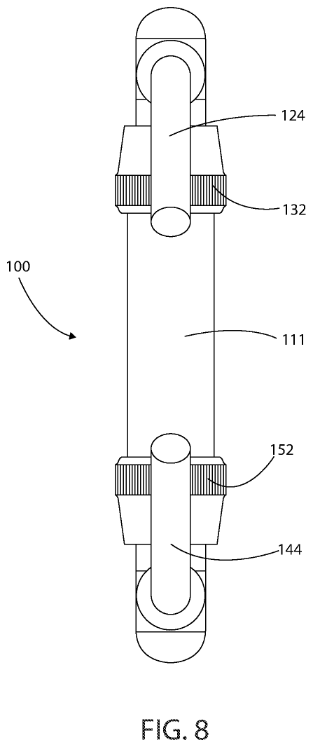

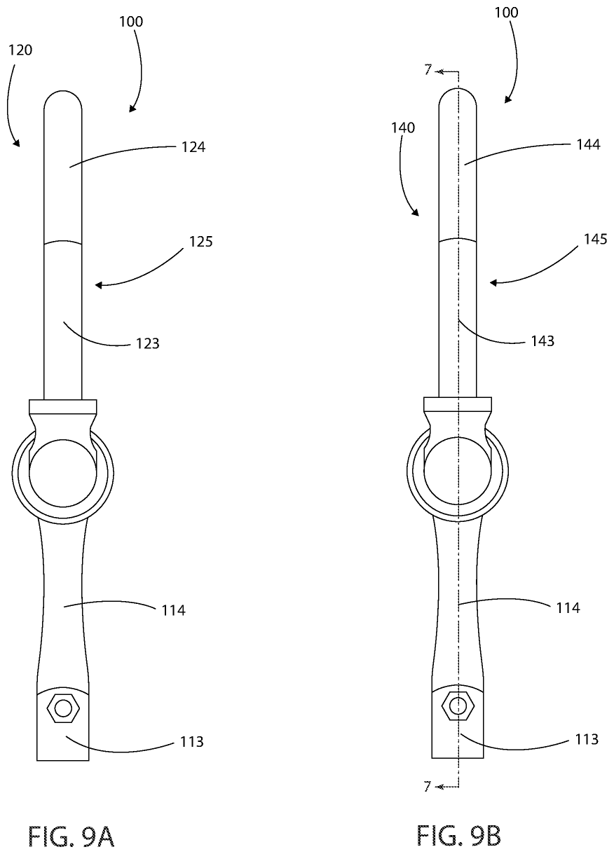

Referring now more specifically to the drawings by numerals of reference, there is shown in FIGS. 1-11, various views of an exercise apparatus 100. As shown, the exercise apparatus 100 may comprise a main frame 110, a left handle assembly 120, a left resistance assembly 130, a right handle assembly 140 and a right resistance assembly 150.

Referring specifically to FIG. 1, as shown, the exercise apparatus 100 may be configured for attachment to a stroller 10. The stroller 10 may include a stroller handle 15. The exercise apparatus 100 may be configured for exercising an upper body of a user 5. Particularly, the exercise apparatus 100 may be configured for exercising arms of the user 5. For example, as shown in FIG. 1, the user 5 may utilize the exercise apparatus 100 to exercise their arms whilst using the stroller 10 to push their child. Preferably, the exercise apparatus 100 may be detachable from the stroller 10. As such, it is contemplated that the exercise apparatus 100 may be selectively attached to any stroller 10. In other embodiments, the stroller 10 may be provided with the exercise apparatus 100.

As shown, the main frame 110 may include a crossbar 111 and a bracket 113. Further, the crossbar 111 may include a left side 115 and a right side 116 relative to the stroller handle 15. The bracket 113 may be attached to a bottom 112 of the crossbar 111 and may be configured to attach the exercise apparatus 100 to the stroller handle 15 (FIG. 1). As shown, an elongated section 114 may extend between the bottom 112 of the crossbar 111 and the bracket 113. The elongated section 114 may include curved sides. As above, preferably, the exercise apparatus 100 may be selectively attached to any stroller 10. As such, the bracket 113 may be universal to fit most stroller handles 15.

In some embodiments, as shown in FIGS. 1-4, the exercise apparatus 100 may further comprise an attachment plate 160. As shown in FIG. 1, the attachment plate 160 may be configured for attachment to the stroller handle 15 and the bracket 113 may be configured for installation to the attachment plate 160. For example, in some embodiments, the bracket 113 may attach to the attachment plate 161 via bolts and nuts, screws, etc. In other embodiments, the bracket 113 may be permanent to the attachment plate 160. For example, the bracket 113 may be fused to the attachment plate 160.

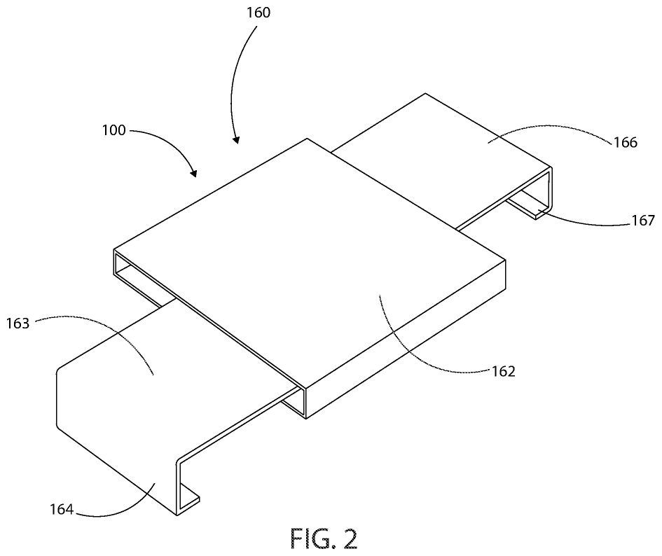

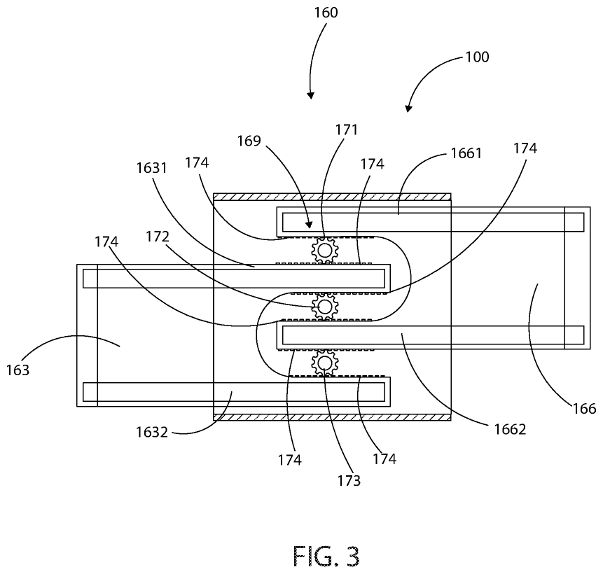

As shown in FIGS. 2-4, the attachment plate 160 may include a plate housing 162, a left side plate 163 including a left clamp 164 and a left adjustment means 165, a right side plate 166 including a right clamp 167 and a right adjustment means 168 and a side plate mover system 169 housed within the plate housing 162. As shown in FIG. 3, the side plate mover system 169 may be in communication with the left side plate 163 and the right side plate 166 such that the left side plate 163 and the right side plate 166 may be selectively extendable from the plate housing 162. For example, in some embodiments, as shown in FIG. 3, the side plate mover system 169 may include a gear and tooth system. As shown, there may be three gears 171, 172, 173 housed within the plate housing 162. The left side plate 163 may include two left arms 1631, 1632 and the right side plate 166 may include two right arms 1661, 1662. The left arms 1631, 1632 and the right arms 1661, 1662 may include a plurality of teeth 174 thereon for mating with the three gears 171, 172, 173. As such, the side plates 163, 166 may be pulled out of the plate housing 162.

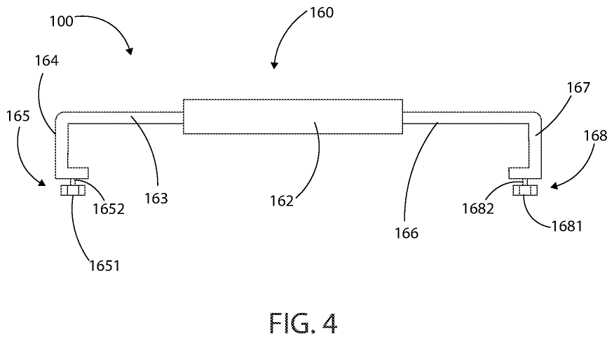

The left clamp 164 may attach to a left side of the stroller handle 15 and the right clamp 167 may attach to the right side of the stroller handle 15 (as shown in FIG. 1). As shown in FIG. 4, the adjustment means 165, 168 may include knobs 1651, 1681 that mate with a threaded rod 1652, 1682 at a rear of each clamp 164, 167. Rotation of the knobs 1651, 1681 may push the threaded rods 1652, 1682 into the stroller handle 15 to secure to the clamps 164, 167 thereto.

As shown in FIG. 1 and FIGS. 5-9B, the left handle assembly 120 may be located about the left side 115 of the crossbar 111. The left handle assembly 120 may include a first left horizontal section 121, a second left horizontal section 122, a left vertical section 123 and a left substantially angled section 124 (angled relative to the left vertical section 123). As shown, the left substantially angled section 124 may be attached to the left vertical section 123 and together may define a left grippable portion 125 of the left handle assembly 120.

Similarly, the right handle assembly 140 may be located about the right side 116 of the crossbar 111. The right handle assembly 140 may include a first right horizontal section 141, a second right horizontal section 142, a right vertical section 143 and a right substantially angled section 144 (angled relative to the right vertical section 143). The right substantially angled section 144 may be attached to the right vertical section 143 and together and may define a right grippable portion 145 of the right handle assembly 140. The grippable portions (125, 145) may be what the user 5 grasps for use in exercising their arms. For example, in some embodiments, the user 5 may grasp the vertical sections (123, 143). In other embodiments, the user 5 may grasp the substantially angled sections (124, 144). Depending on where the user 5 grasps, different muscles may be exercised. Further, in some embodiments, the grippable portions 125, 145 may include comfort means such as gel and/or foam padding.

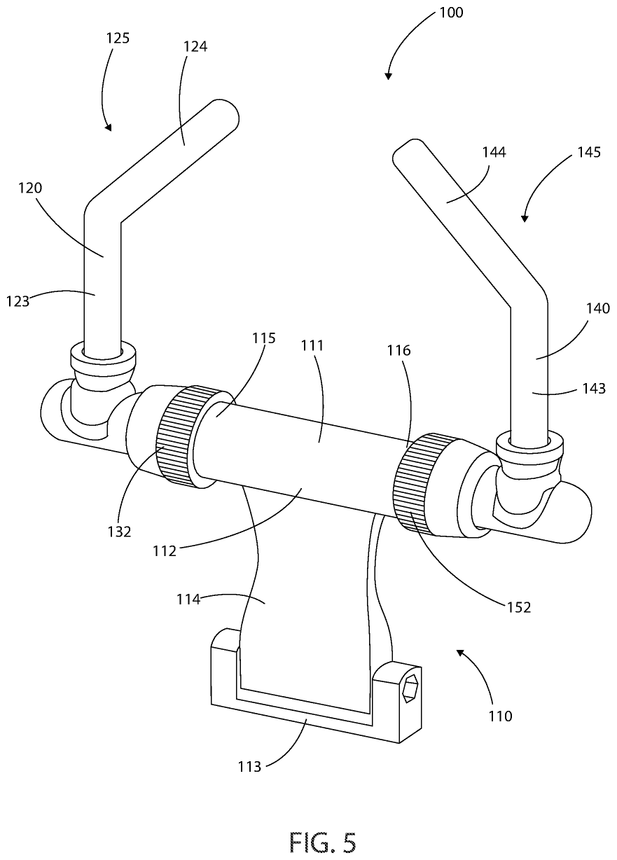

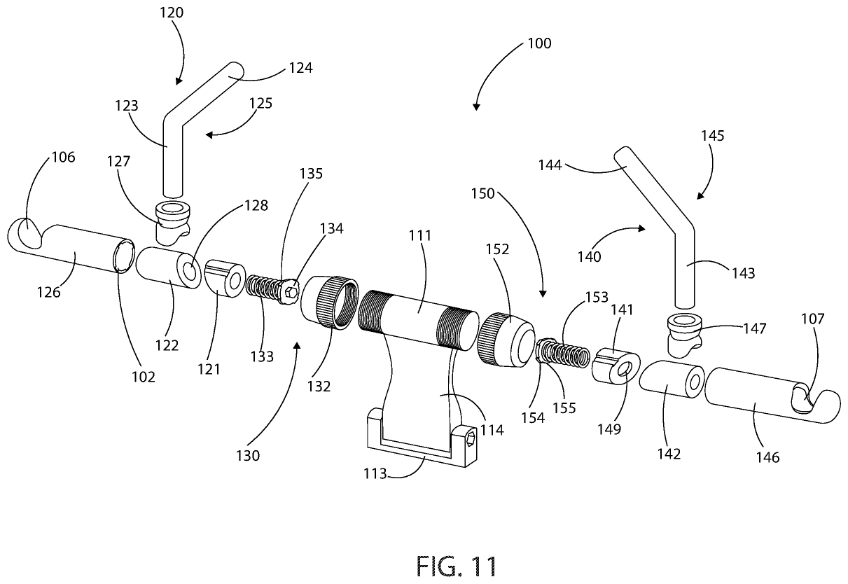

As shown in FIGS. 5-11, the left vertical section 123 may be attached to the second left horizontal section 122 and the second left horizontal section 122 may be pivotably attached to the first left horizontal section 121 such that the left handle assembly 120 may be pivotable about a horizontal axis 20 (the horizontal axis 20 relative to the stroller handle 15). As shown, the right vertical section 143 may be attached to the second right horizontal section 142 and second right horizontal section 142 may be pivotably attached to the first right horizontal section 141 such that the right handle assembly 140 is pivotable about the horizontal axis 20. For example, in some embodiments as shown in FIG. 11, the second horizontal sections 122, 142 may include protuberances 128 and the first horizontal sections 121, 141 may include cavities 149 configured to receive the (respective) protuberances 128.

The pivotability of the second horizontal sections 122, 142 relative to the first horizontal sections 121, 142 may allow the user 5 to grasp the grippable portions 125, 145 and push and/or pull them forward and/or backward to further exercise the arms. For example, the handle assemblies may be pivotable at least 90 degrees in a forward direction and at least 90 degrees in a backward direction.

As shown, the left handle assembly 120 may further comprises a left jacket 127 attached between the second left horizontal section 122 and the first left vertical section 123 and the left jacket 127 may circumscribe the left vertical section 123. The right handle assembly 140 further may further comprise a right jacket 147 attached between the second right horizontal section 142 and the right vertical section 143 and the right jacket 147 may circumscribe the right vertical section 143. For example, the jackets 127, 147 may include apertures with diameters similar to diameters of the vertical sections 123, 143.

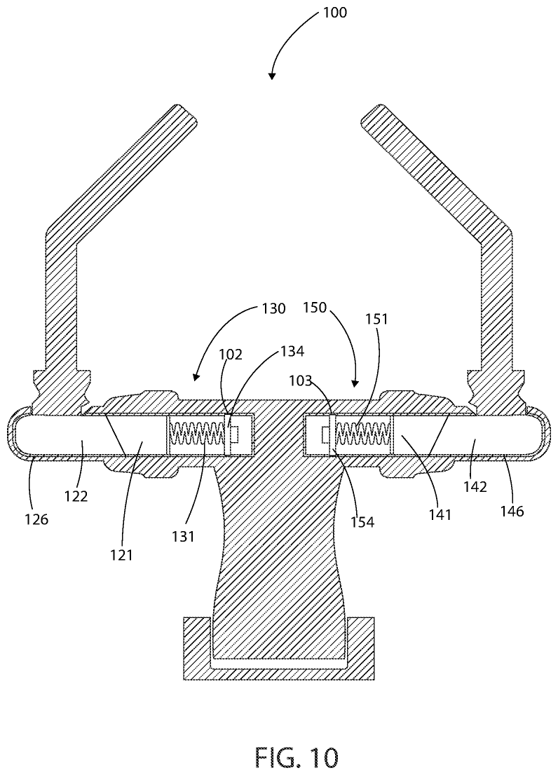

As shown in FIGS. 10-11, the left resistance assembly 130 may be housed within a left side 115 of the crossbar 111 and the right resistance assembly 150 may be housed within a right side 116 of the crossbar 111. As shown, the left resistance assembly 130 may be in communication with the left handle assembly 120. The left resistance assembly 130 may include a left tension means 131 and a left tension dial 132. The left tension means 131 may be in communication with the first left horizontal section 121 of the left handle assembly 120 and the left tension dial 132 may be in communication with the left tension means 131 and configured to place the left tension means 131 in at least a first left position and a second left position.

The right resistance assembly 150 may be in communication with the right handle assembly 140. The right resistance assembly 150 may include a right tension means 151 and a right tension dial 152. The right tension means 151 may be in communication with the first right horizontal section 141 of the right handle assembly 140 and may be in communication with the right tension means 151 and configured to place the right tension means 151 in at least a first right position and a second right position. In some embodiments, the left tension means 131 may include a left spring 133 and a left mover 134. As shown in FIGS. 10-11, the left spring 133 may be attached to the first left horizontal section 121 at one end and the left mover 134 at another end. The right tension means 151 may include a right spring 153 and a right mover 154 and the right spring 153 may be attached to the first right horizontal section 141 at one end and the right mover 154 at another end.

In some embodiments, the first left position may provide a first resistance to pivoting of the left handle assembly 120 and the second left position may provide a second resistance to pivoting of the left handle assembly 120; and the first right position may provide a first resistance to pivoting of the right handle assembly 120 and the second right position may provide a second resistance to pivoting of the right handle assembly 120. For example, the second positions may provide more resistance than the first positions. This may allow the user to utilize resistance in exercising of the arms. In some embodiments, rotation of the left tension dial 132 may place the left tension means 131 in one of the first left position and the second left position and rotation of the right tension dial 152 may place the right tension means 151 in the one of the first right position and the second right position.

Preferably, the tension dials 132, 152 may be configured to place the tension means 131, 151 in more than two positions. For example, in some embodiments, the springs 133, 153 may be compression springs. In this embodiment, the first positions may include the springs 133, 153 held in an expanded position and the second positions may include the springs 133, 153 held in a first compressed position. In further embodiments, the springs 133, 153 may be configured to be held in more than one compressed position. For example, the tension dials 132, 152 may be rotated to a ‘low’ level, placing the springs in the first compressed position; a ‘medium’ level, placing the springs in a second compressed position; and a ‘high’ level, placing the springs in a third compressed position (the third compression position providing more resistance than the first and second compression positions, thus providing greater difficulty in pivoting of the handle assemblies 120, 140 and thus exercising the arms to a higher degree)

In some embodiments, the left handle assembly 120 may further comprise a left sleeve 126 configured to cover the first left horizontal section 121, the second left horizontal section 122 and the left resistance assembly, and the right handle assembly 140 further may comprise a right sleeve 146 configured to cover the first right horizontal section 141, the second right horizontal section 142 and the right resistance assembly 140. As shown the sleeves 126, 146 may include openings 106, 107 for the vertical sections 123, 143 to protrude upwardly therethrough. The second horizontal sections 122, 142 may pivot within the sleeves 126, 146 and as such, the openings 106, 107 may allow for backwards and forwards movement of the vertical sections 123, 143.

In some embodiments, the left sleeve 126 may place the left tension dial 132 in communication with the left mover 134 such that the left tension means 131 is able to cause the left mover 134 to move the left tension means 131 into one of the first left position and the second left position; and the right sleeve 146 may place the right tension dial 152 in communication with the right mover 154 such that the right tension means 151 is able to cause the right mover 154 to move the right tension means 151 into one of the first right position and the second right position. Preferably, rotation of the left tension dial 132 may place the left tension means 131 in one of the first left position and the second left position, and rotation of the right tension dial 152 may place the right tension means 151 in one of the first right position and the second right position.

For example, as shown in FIGS. 10-11, in some embodiments, an interior of the left sleeve 126 may include a set of left grooves 102 and an exterior of the left mover 134 may include a set of left protrusions 135 configured to mate with the set of left grooves 102. Rotation of the left tension dial 132 may rotate the left mover 134 and cause one of compression and release of the left spring 133. Similarly, an interior of the right sleeve 146 may include a set of right grooves 103 and an exterior of the right mover 154 may include a set of right protrusions 155 configured to mate with the set of right grooves 103. Rotation of the right tension dial 152 may rotate the right mover 154 and cause one of compression and expansion of the right spring 153. As such, rotation of the tension dials 132, 152 may selectively compress the springs 133, 153 by pushing the movers 134, 154 into the springs 133, 153 so that the springs 133, 153 are compressed between the first horizontal sections 121, 141 and the movers 134, 154. Further, means for locking the springs 121, 141 in the compressed position(s) may also be included in the resistance assemblies 130, 150. For example, a latch may be configured to hold the springs 121, 141 in the compressed position(s) with each rotation of the tension dials 132, 152.

It should also be noted that, under appropriate circumstances, considering such issues as design preference, user preferences, marketing preferences, cost, structural requirements, available materials, technological advances, etc., other methods for exercising the arms whilst pushing a stroller are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An exercise apparatus for exercising an upper body of a user, the exercise apparatus configured for attachment to a stroller, the stroller including a stroller handle, the exercise apparatus including comprising:
a main frame including a crossbar and a bracket, the bracket attached to a bottom of the crossbar and being configured to attach the exercise apparatus to the stroller handle, the crossbar including a left side and a right side relative to the stroller handle;
a left handle assembly located about the left side of the crossbar, the left handle assembly including a first left horizontal section, a second left horizontal section, a left vertical section and a left substantially angled section, the substantially angled section attached to the left vertical section and together defining a left grippable portion of the left handle assembly, the left vertical section being attached to the second left horizontal section and the second left horizontal section being pivotably attached to the first left horizontal section such that the left handle assembly is pivotable about a horizontal axis, the horizontal axis relative to the stroller handle;
a left resistance assembly in communication with the left handle assembly, the left resistance assembly including a left tension means and a left tension dial, the left tension means being in communication with the first left horizontal section of the left handle assembly, the left tension dial being in communication with the left tension means and configured to place the left tension means in at least a first left position and a second left position, the first left position providing a first resistance to pivoting of the left handle assembly and the second left position providing a second resistance in pivoting the left handle assembly;
a right handle assembly located about the right side of the crossbar, the right handle assembly including a first right horizontal section, a second right horizontal section, a right vertical section and a right substantially angled section, the right substantially angled section attached to the right vertical section and together defining a right grippable portion of the right handle assembly, the right vertical section being attached to the second right horizontal section and the second right horizontal section being pivotably attached to the first right horizontal section such that the right handle assembly is pivotable about the horizontal axis; and
a right resistance assembly in communication with the right handle assembly, the right resistance assembly including a right tension means and a right tension dial, the right tension means being in communication with the first right horizontal section of the right handle assembly, the right tension dial being in communication with the right tension means and configured to place the right tension means in at least a first right position and a second right position, the first right position providing a first resistance to pivoting of the right handle assembly and the second right position providing a second resistance to pivoting of the right handle assembly.

2. The exercise apparatus of claim 1, further comprising an attachment plate configured for attachment to the stroller handle, and wherein the bracket is configured for installation to the attachment plate.

3. The exercise apparatus of claim 2, wherein the attachment plate includes a plate housing, a left side plate including a left clamp and a left adjustment means, a right side plate including a right clamp and a right adjustment means and a side plate mover system housed within the plate housing, and wherein the side plate mover system is in communication with the left side plate and the right side plate such that the left side plate and the right side plate are selectively extendable from the plate housing.

4. The exercise apparatus of claim 1, wherein the left resistance assembly is housed within a left side of the crossbar, and wherein the right resistance assembly is housed within a right side of the crossbar.

5. The exercise apparatus of claim 4, wherein the left tension means includes a left spring and a left mover, wherein the left spring is attached to the first left horizontal section at one end and the left mover at another end, wherein the right tension means includes a right spring and a right mover, and wherein the right spring is attached to the first right horizontal section at one end and the right mover at another end.

6. The exercise apparatus of claim 5, wherein the left spring and the right spring are compression springs.

7. The exercise apparatus of claim 6, wherein the first left position and the first right position includes the left spring and the right spring held at an expanded position, and wherein the second left position and second right position includes the left spring and the right spring held at a first compressed position.

8. The exercise apparatus of claim 7, wherein the left handle assembly and the right handle assembly are pivotable at least 90 degrees in a forward direction, and wherein the left handle assembly and the right handle assembly are pivotable at least 90 degrees in a backward direction.

9. The exercise apparatus of claim 1, wherein the left handle assembly further comprises a left sleeve configured to cover the first left horizontal section, the second left horizontal section and the left resistance assembly, and wherein the right handle assembly further comprises a right sleeve configured to cover the first right horizontal section, the second right horizontal section and the right resistance assembly.

10. The exercise apparatus of claim 8, wherein the left sleeve places the left tension dial in communication with the left mover such that the left tension dials is able to cause the left mover to move the left tension means into one of the first left position and the second left position, and wherein the right sleeve places the right tension dial in communication with the right mover such that the right tension dial is able to cause the right mover to move the right tension means into one of the first right position and the second right position.

11. The exercise apparatus of claim 10, wherein rotation of the left tension dial places the left tension means in one of the first left position and the second left position, and wherein rotation of the right tension dial places the right tension means in one of the first right position and the second right position.

12. The exercise apparatus of claim 11, wherein an interior of the left sleeve includes a set of left grooves, wherein an exterior of the left mover includes a set of left protrusions configured to mate with the set of left grooves, wherein rotation of the left tension dial rotates the left mover and causes one of compression and release of the left spring, wherein an interior of the right sleeve includes a set of right grooves, wherein an exterior of the right mover includes a set of right protrusions configured to mate with the set of right grooves, and wherein rotation of the right tension dial rotates the right mover and causes one of compression and expansion of the right spring.

13. An exercise apparatus for exercising an upper body of a user, the exercise apparatus configured for attachment to a stroller, the stroller including a stroller handle, the exercise apparatus including comprising:
a main frame including a crossbar and a bracket, the bracket attached to a bottom of the crossbar and being configured to attach the exercise apparatus to the stroller handle, the crossbar including a left side and a right side relative to the stroller handle;
a left handle assembly located about the left side of the crossbar, the left handle assembly including a first left horizontal section, a second left horizontal section, a left vertical section and a left substantially angled section, the substantially angled section attached to the left vertical section and together defining a left grippable portion of the left handle assembly, the left vertical section being attached to the second left horizontal section and second left horizontal section being pivotably attached to the first left horizontal section such that the left handle assembly is pivotable about a horizontal axis, the horizontal axis relative to the stroller handle;
a left resistance assembly in communication with the left handle assembly, the left resistance assembly including a left tension means and a left tension dial, the left tension means being in communication with the first left horizontal section of the left handle assembly, the left tension dial being in communication with the left tension means and configured to place the left tension means in at least a first left position and a second left position, the left tension means including a left spring and a left mover, the left spring being attached to the first left horizontal section at one end and the left mover at another end, the first left position providing a first resistance to pivoting of the left handle assembly, the second left position providing a second resistance to pivoting of the left handle assembly;
a right handle assembly located about the right side of the crossbar, the right handle assembly, the right handle assembly including a first right horizontal section, a second right horizontal section, a right vertical section and a right substantially angled section, the right substantially angled section attached to the right vertical section and together defining a right grippable portion of the right handle assembly, the right vertical section being attached to the second right horizontal section and the second right horizontal section being pivotably attached to the first right horizontal section such that the right handle assembly is pivotable about the horizontal axis; and
a right resistance assembly in communication with the right handle assembly, the right resistance assembly including a right tension means and a right tension dial, the right tension means being in communication with the first right horizontal section of the right handle assembly, the right tension means including a right spring and a right mover, the right spring being attached to the first right horizontal section at one end and the right mover at another end, the right tension dial being in communication with the right tension means and configured to place the right tension means in at least a first right position and a second right position, the first right position providing a first resistance to pivoting of the right handle assembly, the second right position providing a second resistance to pivoting of the right handle assembly; and
wherein the left handle assembly and the right handle assembly are pivotable at least 90 degrees in a forward direction, and wherein the left handle assembly and the right handle assembly are pivotable at least 90 degrees in a backward direction.

14. The exercise apparatus of claim 13, wherein the left spring and the right spring are compression springs, wherein the first left position and the first right position includes the left spring and the right spring held at an expanded position, and wherein the second left position and the second right position includes the left spring and the right spring held at a first compressed position.

15. The exercise apparatus of claim 14, wherein the left handle assembly further comprises a left sleeve configured to cover the first left horizontal section, the second left horizontal section and the left resistance assembly, and wherein the right handle assembly further comprises a right sleeve configured to cover the first right horizontal section, the second right horizontal section and the right resistance assembly.

16. The exercise apparatus of claim 15, wherein the left sleeve places the left tension dial in communication with the left mover such that the left tension dials is able to cause the left mover to move the left tension means into one of the first left position and the second left position, and wherein the right sleeve places the right tension dial in communication with the right mover such that the right tension dial is able to cause the right mover to move the right tension means into one of the first right position and the second right position.

17. The exercise apparatus of claim 16, wherein rotation of the left tension dial places the left tension means in one of the first left position and the second left position, and wherein rotation of the right tension dial places the right tension means in one of the first right position and the second right position.

18. The exercise apparatus of claim 17, wherein an interior of the left sleeve includes a set of left grooves, wherein an exterior of the left mover includes a set of left protrusions configured to mate with the set of left grooves, wherein rotation of the left tension dial rotates the left mover and causes one of compression and release of the left spring, wherein an interior of the right sleeve includes a set of right grooves, wherein an exterior of the right mover includes a set of right protrusions configured to mate with the set of right grooves, and wherein rotation of the right tension dial rotates the right mover and causes one of compression and expansion of the right spring.

19. The exercise apparatus of claim 13, further comprising an attachment plate configured for attachment to the stroller handle, wherein the bracket is configured for installation to the attachment plate, wherein the attachment plate includes a plate housing, a left side plate including a left clamp and a left adjustment means, a right side plate including a right clamp and a right adjustment means, a side plate mover system housed within the plate housing, and wherein the side plate mover system is in communication with the left side plate and the right side plate such that the left side plate and the right side plate are selectively extendable from the plate housing.

20. An exercise apparatus for exercising an upper body of a user, the exercise apparatus configured for attachment to a stroller, the stroller including a stroller handle, the exercise apparatus including comprising:
a main frame including a crossbar and a bracket, the bracket attached to a bottom of the crossbar and being configured to attach the exercise apparatus to the stroller handle, the crossbar including a left side and a right side relative to the stroller handle;
an attachment plate configured for attachment to the stroller handle, the bracket being configured for installation to the attachment plate, the attachment plate including a plate housing, a left side plate including a left clamp and a left adjustment means, a right side plate including a right clamp and a right adjustment means, and a side plate mover system housed within the plate housing, the side plate mover system being in communication with the left side plate and the right side plate such that the left side plate and the right side plate are selectively extendable from the plate housing;
a left handle assembly located about the left side of the crossbar, the left handle assembly including a first left horizontal section, a second left horizontal section, a left vertical section, a left substantially angled section, and a left sleeve, the substantially angled section attached to the left vertical section and together defining a left grippable portion of the left handle assembly, the left vertical section being attached to the second left horizontal section and the second left horizontal section being pivotably attached to the first left horizontal section such that the left handle assembly is pivotable about a horizontal axis, the horizontal axis relative to the stroller handle, the left sleeve configured to cover the first left horizontal section, the second left horizontal section and the left resistance assembly;
a left resistance assembly in communication with the left handle assembly, the left resistance assembly including a left tension means and a left tension dial, the left tension dial being in communication with the left tension means and configured to place the left tension means in at least a first left position and a second left position, the left tension means including a left spring and a left mover, the left spring being attached to the first left horizontal section at one end and the left mover at another end, the left spring being a compression spring, the first left position providing a first resistance to pivoting of the left handle assembly, the second left position providing a second resistance to pivoting of the left handle assembly, the second left position including the left spring held at an expanded position and the second left position including the left spring held at a first compressed position;
a right handle assembly located about the right side of the crossbar, the right handle assembly including a first right horizontal section, a second right horizontal section, a right vertical section, a right substantially angled section, and a right sleeve, the substantially angled section attached to the right vertical section and together defining a right grippable portion of the right handle assembly, the right vertical section being attached to the second right horizontal section and the second right horizontal section being pivotably attached to the first right horizontal section such that the right handle assembly is pivotable about the horizontal axis, the horizontal axis relative to the stroller handle, the right sleeve configured to cover the first right horizontal section, the second right horizontal section and the right resistance assembly; and
a right resistance assembly in communication with the right handle assembly, the right resistance assembly including a right tension means and a right tension dial, the right tension dial being in communication with the right tension means and configured to place the right tension means in at least a first right position and a second right position, the right tension means including a right spring and a right mover, the right spring being attached to the first right horizontal section at one end and the right mover at another end, the right spring being a compression spring, the first right position providing a first resistance to pivoting of the right handle assembly, the second right position providing a second resistance to pivoting of the right handle assembly, the second right position including the right spring held at an expanded position and the second right position including the right spring held at a first compressed position; and
wherein the left handle assembly and the right handle assembly are pivotable at least 90 degrees in a forward direction, and wherein the left handle assembly and the right handle assembly are pivotable at least 90 degrees in a backward direction;
wherein the left sleeve places the left tension dial in communication with the left mover such that the left tension dials is able to cause the left mover to move the left tension means into one of the first left position and the second left position;
wherein the right sleeve places the right tension dial in communication with the right mover such that the right tension dial is able to cause the right mover to move the right tension means into one of the first right position and the second right position;
wherein rotation of the left tension dial places the left tension means in one of the first left position and the second left position;
wherein rotation of the right tension dial places the right tension means in one of the first right position and the second right position;
wherein an interior of the left sleeve includes a set of left grooves;
wherein an exterior of the left mover includes a set of left protrusions configured to mate with the set of left grooves;
wherein rotation of the left tension dial rotates the left mover and causes one of compression and release of the left spring;
wherein an interior of the right sleeve includes a set of right grooves;
wherein an exterior of the right mover includes a set of right protrusions configured to mate with the set of right grooves;
wherein rotation of the right tension dial rotates the right mover and causes one of compression and expansion of the right spring;
